(19) United States
(12) Patent Application Publication
(10) Pub. No.: US 2002/0059233 A1
(43) Pub. Date: May 16, 2002

(54) Method and system in an electronic spreadsheet for applying user-defined options

(75) Inventors: Frederic Bauchot, St Jeannet (FR); Albert Harari, Nice (FR)

Correspondence Address: David A. Mims, Jr., IBM Corporation, Intellectual Property Law Dept., 11400 Burnet Road-Internal Zip 4054, Austin, TX, 78758, US

(73) Assignee: International Business Machines Corporation, Armonk, NY

(21) Appl. No.: 09/838,367

(22) Filed: Apr. 19, 2001

(30) Foreign Application Priority Data
Jul. 13, 2000 (FR) 00480062.9

(51) Int. Cl. G06F 7/00

(52) U.S. Cl. 707/7

(57) ABSTRACT

The present invention relates to the field of information processing by digital computers, and more particularly to a method and system, in an electronic spreadsheet, of applying one or a plurality of user-defined options within one or a plurality of cells. The method comprises the steps of:

defining for each option a boolean variable with a first value and a second value, preferably a “true” or “false” value;

for each of said one or plurality of cells:

referencing one or a plurality of boolean variables;

associating a logical or mathematical operation with each boolean variable;

for each of said one or plurality of referenced boolean variables in each of said one or plurality of cells:

specifying a default value, said default value being defined as the value of the cell when the referenced boolean variable is set to the first value, preferably when the boolean variable is set to the “false” value;

specifying a delta value by applying to the specified cell default value, the operation associated with the referenced boolean variable when the boolean variable is set to the second value, preferably when the boolean variable is set to the “true” value;

setting each boolean variable to the first value or to the second value;

for each of said one or plurality of cells:

computing said one or plurality of delta values.

### TECHNICAL FIELD OF THE INVENTION

The present invention relates to the field of information processing by digital computers, and more particularly to a method and system, in an electronic spreadsheet, for applying user-defined options.

### BACKGROUND ART

Before computers, numerical analyses, particularly financial ones, were usually prepared on an accountant's columnar pad or spreadsheet, with pencil and calculator in hand. By organising data into columns and rows, spreadsheets afford the rapid assimilation of information by a reader. The task of preparing a spreadsheet on paper, however, is not quite so fast. Instead, the process tends to be very slow, as each entry must be tediously calculated and entered into the spreadsheet. Since all calculations are the responsibility of the preparer, manually prepared spreadsheets are also prone to errors. Hence, preparation of spreadsheets by hand is slow, tedious, and unreliable.

With the advent of microcomputers, a solution was forthcoming in the form of “electronic spreadsheets.” Better known simply as “spreadsheets,” these software programs provide a computerised replacement for the traditional financial modelling tools: the accountant's columnar pad, pencil, and calculator. In some regards, spreadsheet programs are to those tools what word processors are to typewriters. Spreadsheets offer dramatic improvements in ease of creating, editing, and using financial models.

A typical spreadsheet program configures the memory of a computer to resemble the column/row or grid format of an accountant's columnar pad, thus providing a visible calculator for a user. Because this “pad” exists dynamically in the computer's memory, however, it differs from paper pads in several important ways. Locations in the electronic spreadsheet, for example, must be communicated to the computer in a format which it can understand. A common scheme for accomplishing this is to assign a number to each row in a spreadsheet, a letter to each column, and another letter to each sheet (or page) of the spreadsheet. To reference a location at column A and row 1 of the second page (i.e., the upper-left hand corner), for example, the user types in “B:A1”. In this manner, the spreadsheet defines an addressable storage location or “cell” at each intersection of a row with a column within a given page.

Data entry into an electronic spreadsheet occurs in much the same manner that information would be entered on an accountant's pad. After a screen cursor is positioned at a desired location, the user can enter alphanumeric information. Besides holding text and numeric information, however, spreadsheet cells can store special instructions or “formulas” specifying calculations to be performed on the numbers stored in spreadsheet cells. Such spreadsheet cells can also be defined and named as a range as long as they are arranged as a convex set of cells. A typical example of such a named range simply corresponds to a regular table found in an accountant's pad. In this fashion, range names can serve as variables in an equation, thereby allowing precise mathematical relationships to be defined between cells. The structure and operation of a spreadsheet program, including advanced functions such as functions and macros, are documented in the technical, trade, and patent literature. For an overview, see e.g., Cobb, S., Using Quattro Pro 2, Borland-OsbomeIMcGraw-Mll, 1990; and LeBlond, G. and Cobb, D., Using 1-2-3, Que corp., 1985. The disclosures of each of the foregoing are hereby incorporated by reference.

Electronic spreadsheets offer many advantages over their paper counterparts. For one, electronic spreadsheets are much larger (i.e., hold more information) than their paper counterparts; electronic spreadsheets having thousands or even millions of cells are not uncommon. Spreadsheet programs also allow users t to perform “what-if” scenarios. After a set of computational relationships has been entered into a worksheet, thanks to imbedded formulas for instance, the spread of information can be recalculated using different sets of assumptions, with the results of each recalculation appearing almost instantaneously. Performing this operation manually, with paper and pencil, would require recalculating every relationship in the model with each change made. Thus, electronic spreadsheet systems were invented to solve “what-if” problems, that is, changing an input and seeing what happens to an output.

“What-if” problems can be formally represented by the definition of one or several user-defined options, each of them representing an assumption which can either be set as “TRUE” or “FALSE”. The effect of a single given user defined option can take different forms and requires that the spreadsheet user formally represents this effect thanks to different spreadsheet built-in means. With current spreadsheet technology, such spreadsheet means can be based on the writing of spreadsheet formulas (requiring thus some in-depth knowledge of the formula language and syntax), or can also be based on the utilisation of so-called versions. In both cases, there are several limitations which can turn these spreadsheet means into inefficient and error-prone solutions.

When relying on spreadsheet formulas, the user needs first to master the spreadsheet formula language, something which is by far not an easy task for somebody not used to programming languages. Then the user must define by himself some formal representation of the user-defined options, with the associated means for managing them: this second task is even more difficult as the user cannot rely on any stringent set of rules (as the ones implemented in a language compiler or interpreter) to determine if his work is error-free. Furthermore an electronic spreadsheet prepared by a given user with his/her own way of representing options will be difficult to be used by another user if the latter has not received precise instructions from the former on the way to handle the options. In short, unless mastering advanced programming skills, it is virtually impossible for a regular spreadsheet user to realise and share error-free “what-if” scenario thanks to user-defined options, by solely relying on the spreadsheet built-in formula language.

Current spreadsheet tools implement today the concept of versions and version groups, which represent some advantages with respect to the previous approach. Nevertheless using versions presents also some limitations, as outlined hereafter.

Let first recall the concept of versions, according to the following description found in the on-line help of the 1-2-3 spreadsheet tool from Lotus Corporation. “Versions are sets of different data for the same named range. Each version has a name, a date and time of creation and modification, and the name of the person who created or last modified the version. You can also assign styles and protection settings to a version and attach a comment. For example, you can name a range Revenues and create three versions of the range: HighRev, with values of 600, 500, 400, and 300; MedRev, with values of 500, 400, 300, and 200; and LowRev, with values of 400, 300, 200, and 100. You can create versions of any named range. For example, as well as creating versions of Revenues, you might name another range Expenses and create versions named HighExp, MedExp, and LowExp. When you create versions for a named range, all the versions are stored in the cells of the range. 1-2-3 calculates using the values in the currently displayed version. Any style or data changes you make to cells update the version within that range automatically.”

Once a range of cell is versionned, the user can defined several versions for this range. In the classical case where multiple options must be managed, the number of versions to be defined may become excessive. Indeed if an electronic spreadsheet must address a set of N independent options, any cell whose content depends on these N options should be represented with 2^{N} versions, each of them corresponding to a given combination of these N options. Besides the resulting increase in file and memory storage (leading to degraded performances), this situation may become almost unmanageable for the user, specially in the case where multiple dispersed cells are versionned, even with the concept of version groups allowing to associate versions on different ranges of cells.

### SUMMARY OF THE INVENTION

The present invention relates to the field of information processing by digital computers, and more particularly to a method and system, in an electronic spreadsheet, of applying one or a plurality of user-defined options within one or a plurality of cells. The method comprises the steps of:

defining for each option a boolean variable with a first value and a second value, preferably a “true” or “false” value;

for each of said one or plurality of cells:

referencing one or a plurality of boolean variables;

associating a logical or mathematical operation with each boolean variable;

for each of said one or plurality of referenced boolean variables in each of said one or plurality of cells:

specifying a default value, said default value being defined as the value of the cell when the referenced boolean variable is set to the first value, preferably when the boolean variable is set to the “false” value;

specifying a delta value by applying to the specified cell default value, the operation associated with the referenced boolean variable when the boolean variable is set to the second value, preferably when the boolean variable is set to the “true” value;

setting each boolean variable to the first value or to the second value;

for each of said one or plurality of cells:

computing said one or plurality of delta values.

### BRIEF DESCRIPTION OF THE DRAWINGS

The novel and inventive features believed characteristics of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein:

FIG. 1A is a block diagram of a computer system in which the present invention may be embodied.

FIG. 1B is a block diagram of a software system including an operating system, an application software, and a user interface for carrying out the present invention.

FIG. 1C illustrates the basic architecture and functionality of a graphical user interface in which the present invention may be embodied.

FIG. 2A shows a spreadsheet notebook interface according to the preferred embodiment of the present invention.

FIG. 2B shows the toolbar component of the notebook interface shown in FIG. 2A.

FIGS. 2C and 2D show page identifiers for rapidly accessing and manipulating individual pages of the notebook interface shown in FIG. 2A.

FIG. 3 illustrates a preferred spreadsheet user interface for managing user-defined options, according to the present invention.

FIG. 4 illustrates a preferred spreadsheet user interface for applying user-defined options within a given cell, according to the present invention.

FIG. 5 is a flow chart illustrating a preferred method for applying user-defined options within a given cell, according to the present invention.

FIG. 6 is a simplified flow chart illustrating the system and method according to the present invention.

### DETAILED DESCRIPTION OF THE PREFERRED EMBODIMENT

System Hardware

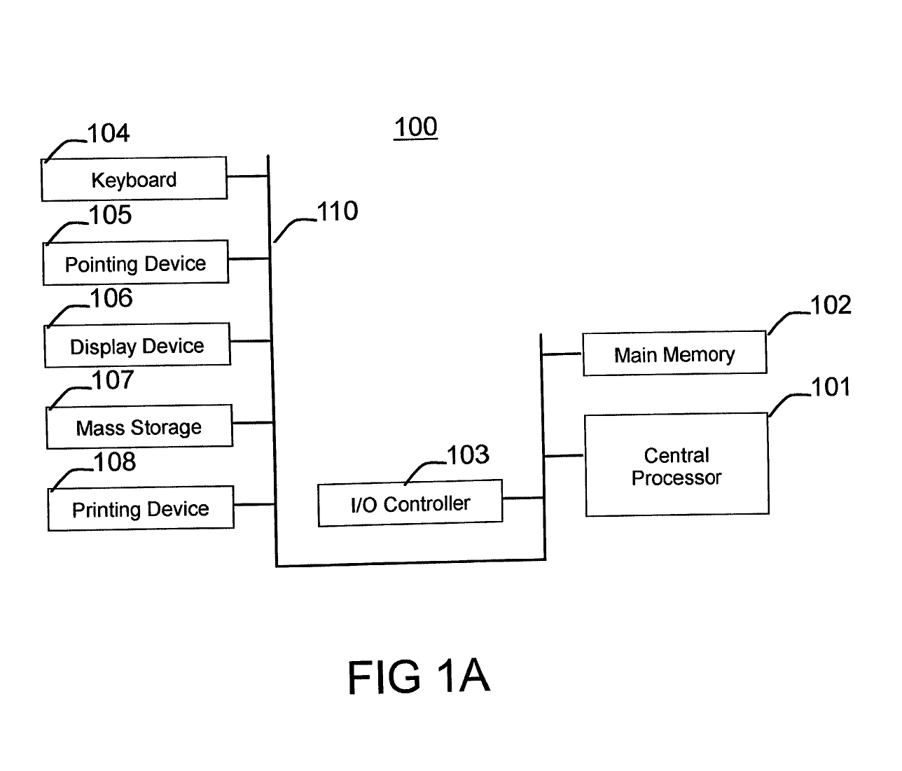

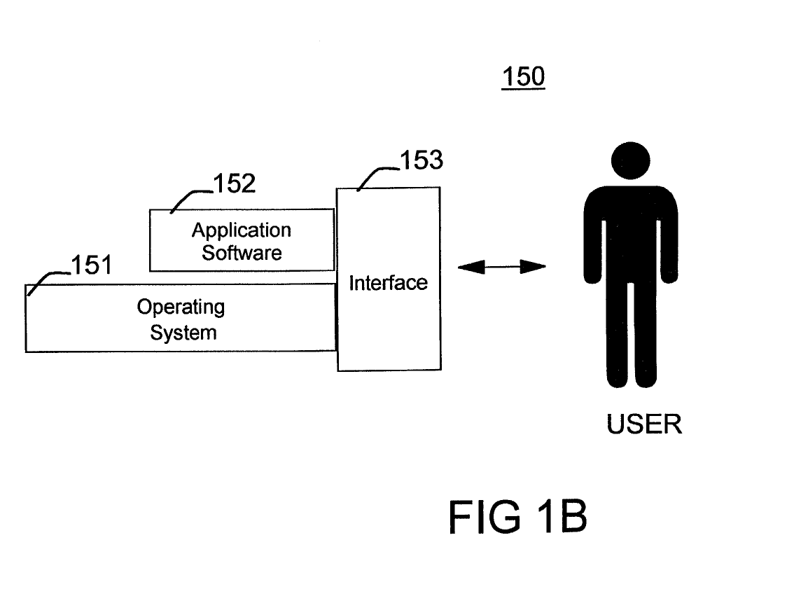

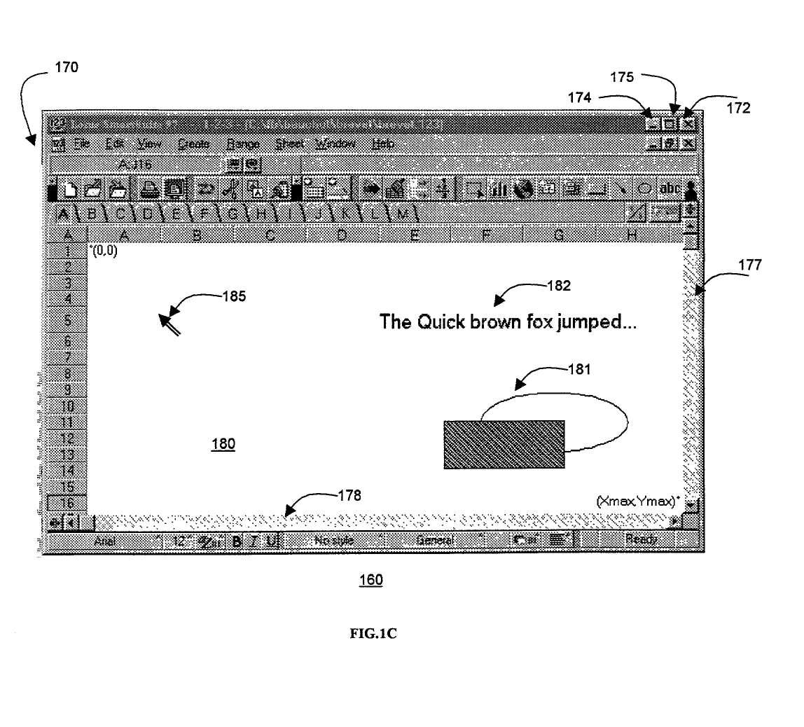

As shown in FIG. 1A, the present invention may be embodied on a computer system 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the system 100 as desired. As illustrated, the various components of the system 100 communicate through a system bus 110 or similar architecture. In a preferred embodiment, the computer system 100 includes an IBM-compatible personal computer, which is available from several vendors (including International Business Machine—IBM Corporation of Armonk, N.Y.).

Illustrated in FIG. 1B, a computer software system 150 is provided for directing the operation of the computer system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the system 100. The system 100 receives user commands and data through user interface 153; these inputs may then be acted upon by the system 100 in accordance with instructions from operating module 151 and/or application module 152. The interface 153, which is preferably a graphical user interface (GUI), also serves to display results, whereupon the user may supply additional inputs or terminate the session. In a preferred embodiment, operating system 151 and interface 153 are Microsoft Win95, available from Microsoft Corporation of Redmond, Wash. Application module 152, on the other hand, includes a spreadsheet notebook of the present invention as described in further detail herein below.

Interface

A. Introduction

The following description will focus on the presently preferred embodiments of the present invention, which are embodied in spreadsheet applications operative in the Microsoft Win95 environment. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, NextStep, and the like. Therefore, the description of the exemplary embodiments which follows is for purposes of illustration and not limitation.

Referring now to FIG. 1C, the system 100 includes a windowing interface or workspace 160. Window 160 is a rectangular, graphical user interface (GUI) for display on screen 106; additional windowing elements may be displayed in various sizes and formats (e.g., tiled or cascaded), as desired. At the top of window 160 is a menu bar 170 with a plurality of user-command choices, each of which may invoke additional submenus and software tools for use with application objects. Window 160 includes a client area 180 for displaying and manipulating screen objects, such as graphic object 181 and text object 182. In essence, the client area is a workspace or viewport for the user to interact with data objects which reside within the computer system 100.

Windowing interface 160 includes a screen cursor or pointer 185 for selecting and otherwise invoking screen objects of interest. In response to user movement signals from the pointing device 105, the cursor 185 floats (i.e., freely moves) across the screen 106 to a desired screen location. During or after cursor movement, the user may generate user-event signals (e.g., mouse button “clicks” and “drags”) for selecting and manipulating objects, as is known in the art. For example, Window 160 may be closed, re-sized, or scrolled by “clicking” (selecting) screen components 172, 174/5, and 177/8, respectively.

In a preferred embodiment, screen cursor 185 is controlled with a mouse device. Single-button, double-button, or triple-button mouse devices are available from a variety of vendors, including Apple Computer of Cupertino, Calif., Microsoft Corporation of Redmond, Wash., and Logitech Corporation of Fremont, Calif., respectively. More preferably, screen cursor control device 105 is a two-button mouse device, including both right and left “mouse buttons.”

Programming techniques and operations for mouse devices are well documented in the programming and hardware literature; see e.g., Microsoft Mouse Programmer's Reference, Microsoft Press, 1989. The general construction and operation of a GUI event-driven system, such as Windows, is also known in the art: see, e.g., Petzold, C., Programming Windows, Second Edition, Microsoft Press, 1990. The disclosures of each are hereby incorporated by reference.

B. Preferred Interface

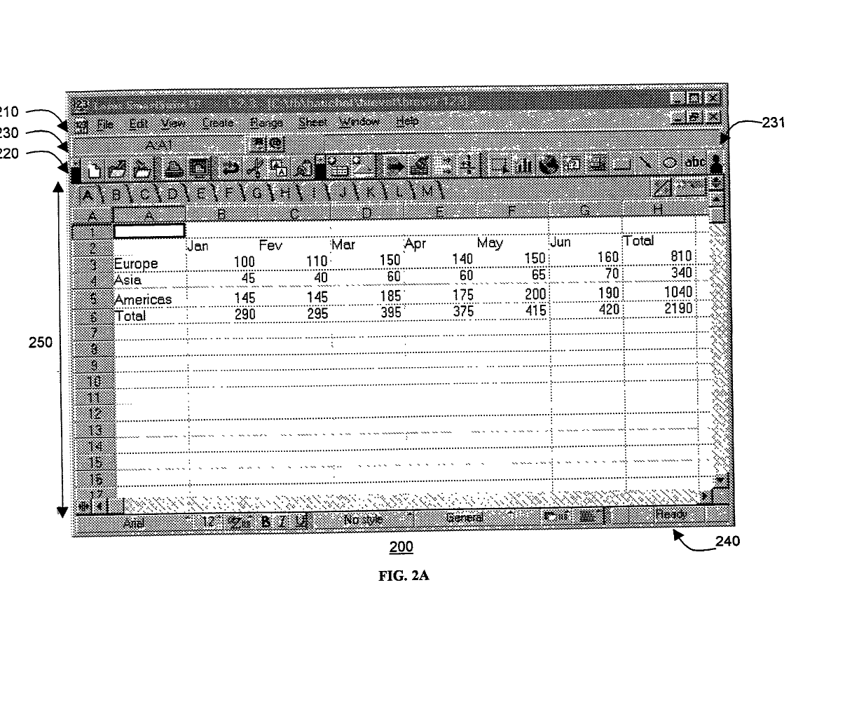

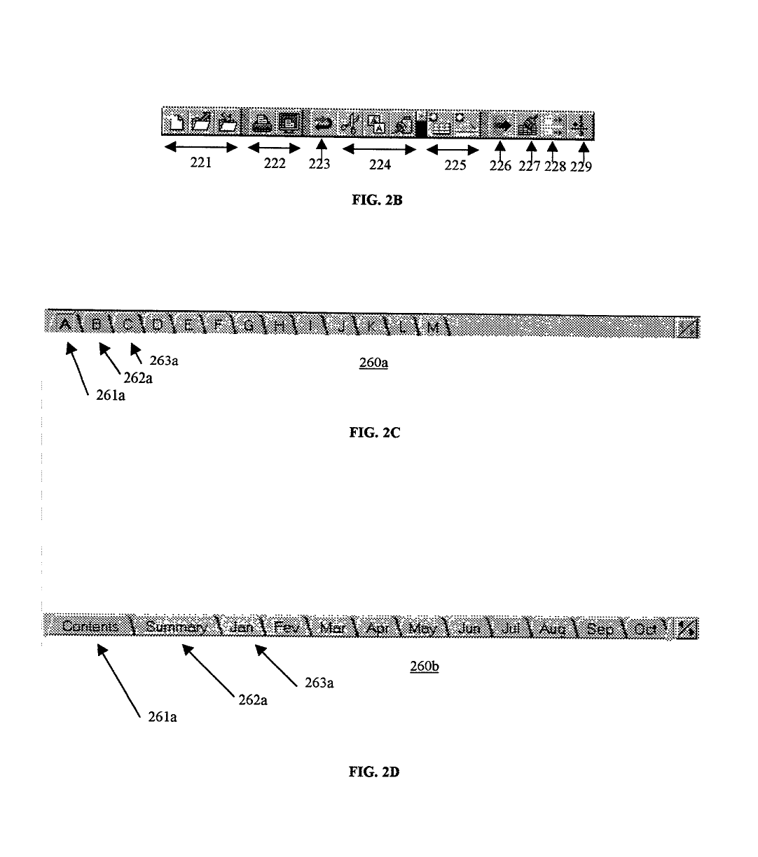

Shown in FIG. 2A, a spreadsheet notebook interface of the present invention will now be described The spreadsheet notebook or workbook of the present invention includes a notebook workspace 200 for receiving, processing, and presenting information, including alphanumeric as well as graphic information. Notebook workspace 200 includes a menu bar 210, a toolbar 220, a current cell indicator 230, an input line 231, a status line 240, and a notebook window 250. The menu bar 210 displays and invokes, in response to user inputs, a main level of user commands. Menu 210 also invokes additional pull down menus, as is known in windowing applications. Input line 231 accepts user commands and information for the entry and editing of cell contents, which may include data, formulas, macros, and the like. Indicator 230 displays an address for the current cursor (i.e., active cell) position, or the address or name of a selected named range (i.e. active selection). At the status line 240, system 100 displays information about the current state of the workbook; for example, a “READY” indicator means that the system is ready for the user to select another task to be performed.

The toolbar 220, shown in further detail in FIG. 2B, comprises a row or palette of tools which provide a quick way for the user to choose commonly-used menu commands or properties. In an exemplary embodiment, toolbar 220 includes file manipulation buttons 221, printing buttons 222, an undo button 223, cut, copy, and paste buttons 224, information pop-up window buttons tool 225, a named range selection button 226, a style copy button 227, a column re-sizing button 228, and a sum button 229. The functions of these buttons are suggested by their names. For instance, buttons 224 cut, copy and paste data and objects to and from Windows' clipboard. The same actions are also available as corresponding commands in the Edit menu (available from menu bar 210).

The notebook, which provides an interface for entering and displaying information of interest, includes a plurality of spreadsheet pages. Each page may include conventional windowing features and operations, such as moving, re-sizing, and deleting. In a preferred embodiment, the notebook includes 256 spreadsheet pages, all of which are saved as a single disk file on the mass storage 107. Workspace 200 may display one or more notebooks, each sized and positioned (e.g., tiled, overlapping, and the like) according to user-specified constraints.

Each spreadsheet page of a notebook includes a 2-D spread. Page A from the notebook 200, for example, includes a grid in row and column format, such as row 3 and column F. At each row/column intersection, a box or cell (e.g., cell C4) is provided for entering, processing, and displaying information in a conventional manner. Each cell is addressable, with a selector being provided for indicating a currently active one (i.e., the cell that is currently selected).

As shown in FIGS. 2C-D, individual notebook pages are identified by page identifiers 260, preferably located along one edge of a notebook. In a preferred embodiment, each page identifier is in the form of a tab member (e.g., members 261a, 262a, 263a) situated along a top edge of the notebook. Each tab member may include representative indicia, such as textual or graphic labels, including user selected titles representing the contents of a corresponding page. In FIG. 2C, the tab members 260 are set to their respective default names. For example, the first three tab members (members 261a, 262a, 263a) are respectively set to A, B, and C. Tab members are typically given descriptive names provided by the user, however. As shown in FIG. 2D, for example, the first three tab members have now been set to “Contents” (tab member 261b), “Summary” (tab member 262b), and “Jan” (tab member 263b). In a similar manner, the remaining tabs are set to subsequent months of the year. In this manner, the user associates the page identifiers with familiar tabs from an ordinary paper notebook. Thus, the user already knows how to select a page or spread of interest: simply select the tab corresponding to the page (as one would do when selecting a page from a paper notebook).

In addition to aiding in the selection of an appropriate page of information, the user-customizable page identifiers serve aid in the entry of spreadsheet named range addresses. For example, when entering a formula referring to a named range of cells on another page, the user may simply use the descriptive page name in the named range address, thus making it easier for the user to understand the relationship of the cell(s) or information being referenced.

A general description of the features and operation of the spreadsheet notebook interface may be found in Quattro Pro for Windows (Getting Started, User's Guide and Building Spreadsheet Applications), available from Borland International.

Management of User-defined Options

A. Introduction

As the power of spreadsheet environments has increased since several years, it is today possible to develop complex custom applications solely based on spreadsheets, as opposed to applications developed with general purpose programming languages like C++ or VisualBasic from Microsoft Corporation. This can be achieved thanks to spreadsheet imbedded tools such as macro languages, script languages, formulas and versions. In typical spreadsheet based applications, it is common to find individual cells or ranges of multiple cells whose content depends on one or several conditions. Running “what-if” scenario can therefore be seen as applying different sets of conditions to such condition dependent cells. With conventional electronic spreadsheet tools, this can be achieved thanks to the concept of version. A version is always associated to a range of cells (whether it contains a single cell or multiple cells) and can be seen as a set of mutually exclusive instances of this range of cells. When multiple independent conditions have to be taken into account for running the “what-if” scenario, the resulting number of versions to be defined varies exponentially with the number of conditions. Indeed with N independent assumptions, there are 2^{N} different combinations of them. With N only equal to 7, 2^{N} is already equal to 128. Thus even with a small number of conditions, there is a quite large number of condition combinations, which can easily hit the limit of the spreadsheet. Furthermore when different cells dispersed within an electronic spreadsheet depend on the same set of conditions, conventional electronic spreadsheet tools propose to use the concept of version groups, which require from the spreadsheet user a careful definition of the dependencies between versions of different cell ranges.

The present invention offer a user-friendly solution to this problem by defining a method and a system for managing and applying user-defined options to a given cell.

In the next sections, the above-mentioned conditions will be referred to as options. An option is defined as a boolean variable, which can be set as “True” or “False” and which may impact the content of any given cell within an electronic spreadsheet, by referencing it just as a conventional named range. For instance the formula “$baseprice *(1-10%*$discount)” refers on one hand to a conventional named range “baseprice” and on the other hand to a named range “discount” which is also defined as an option according to the present invention. In this example, when the option “discount” is “false” (with option value “false” conventionally set to 0), the formula takes the same value as the one contained in the named range “baseprice”. Alternatively, when the option “discount” is “true” (with option value “true” conventionally set to 1), the formula results in a value equal to the value of the named range “baseprice”, decreased by 10%.

In the following sections, a cell where one or several user-defined options are applied will be referred to as an “Option Applied Cell” or OAC.

B. Option Manager and Option Applicator

In contrast to just-described conventional tools, the present invention provides a more powerful, user-friendly and interactive approach for managing user-defined options in the form of an “Option Manager”. The manager automatically allows the electronic spreadsheet user

to define if a given condition deserves to be handled as a so-called Option, and afterwards

to manage this option.

In a preferred embodiment, the present invention is used in three steps

1. The first step occurs when the spreadsheet user decides, based on some criteria not detailed here, if one or several conditions deserve to take advantage of the present invention, that is to be managed as one or several options by the Option Manager.

Option Visualisation

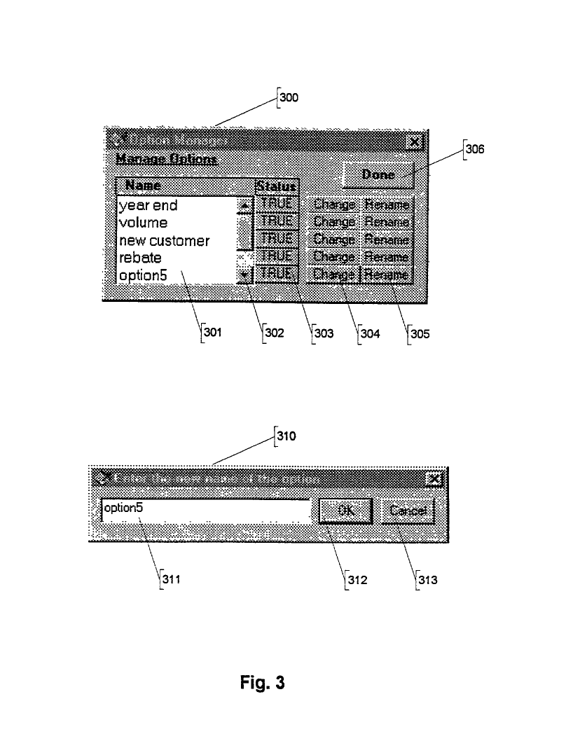

The user first invokes a specific command called “Option_Manager” thanks to conventional means available in spreadsheet environment, such as (but not limited to) dedicated push-buttons, keyboard entry short cuts, menu or sub-menu entries. This result in displaying on the Display device 106 of an Option Manager Dialog Box 300, as shown by FIG. 3. Within this Option Manager Dialog Box 300, the user can visualise already defined options in the “List Box” 301 (such as the ones named “year end”, “volume”, “new customer” and “rebate” as shown in FIG. 3), as well as unused options whose names follow some predefined template, such as “option*” where the character “*” is a wild card for representing numbers. In the example shown in FIG. 3, the bottom option within the List Box 301 is named “option5” and therefore corresponds in this preferred embodiment as an unused option. Any other similar or different naming convention may be used without departing from the spirit of this invention. To visualise any other options, whether already defined or spare, not displayed within the list box 301 of the Option Manager Dialog Box 300, the user can for instance use the pointing device 105 to click on the scroll bar 302, so that the list box 301 can move upwards on downwards along the full set of used and spare options.

Option Definition

The user can typically decides to use the first unused option (“option5” as shown in the list box 301 within the Option Manager Dialog Box 300) for becoming the first new used option. For this purpose the user uses the pointing device 105 to click on the push-button “Rename” 305 located on the right of the “option5” element of the list box 301. This result in displaying on the display device 106 a new dialog box 310. Within this dialog box 310, a user entry field 311 allows the user to change with the keyboard 104 the default option name “option5” into a new one. If at that point the user decides, for any reason not detailed here, not to define a new option, it can cancel this operation by clicking on the push-button “Cancel” 313. This will result in closing the dialog box 310 from the display device 106 and then giving back control to the Option Manager dialog box 300. Alternatively, if the user wants to continue with the new option definition, it confirms the operation by clicking on the push-button “OK” 312 within the dialog box 310. This will result in closing the dialog box 310 from the display device 106 and then giving back control to the Option Manager dialog box 300, which now shows in the bottom of the list box 301 the new name of the just specified option. If the user wants to defined other new options, it can follow the same steps as long as spare options are left unused. When done, the user uses the pointing device 105 to click on the push-button “Done” 306. This will result in closing the Option Manager Dialog Box 300 on the display device 106.

2. The second step occurs when the spreadsheet user decides, based on his or her own criteria not detailed here, to take advantage of the present invention by manipulating already defined options thanks to the Option Manager. Such manipulation can either be to rename one or several already defined options, or to read and/or change the status (between the “True” and “False” status) of one or several already defined options.

Dialog Box

In both cases, the user first invokes a specific command called “Option Manager” thanks to conventional means available in spreadsheet environment, such as (but not limited to) dedicated push-buttons, keyboard entry short cuts, menu or sub-menu entries. This result in displaying on the display device 106 an Option Manager Dialog Box 300, as shown by FIG. 3.

Option Visualisation

Within this Option Manager Dialog Box 300, the user can visualise already defined options in the “List Box” 301 (such as the ones named “year end”, “volume”, “new customer” and “rebate” as shown in FIG. 3). To visualise any other defined options possibly not displayed within the list box 301 of the Option Manager Dialog Box 300, the user can for instance use the pointing device 105 to click on the scroll bar 302, so that the list box 301 can move upwards on downwards along the full set of used and spare options.

Option Renaming

If the user choice is to rename one or several already defined options, then he/she has to follow, for each relevant options, a sequence of steps similar to the ones used to initially define a new option. In short, it consists in first using the scroll bar 302 to display within the list box 301 the option to rename, then to click on the push-button “Rename” standing on the right of the selected option (as the push-button 305 if the selected option appears at the bottom of the list box 301), then to replace by using the keyboard 104 within the displayed dialog box 310 the current option name displayed in the window 311, and then to click on the push-button “OK” 312.

Read/change Option Status

If the user choice is to read and/or change the status of one or several defined options, he/she begins as above to display within the list box 301 (possibly by using the scroll bar 302) the first option whose status must be read and/or updated. Once done, the status of this option is shown in the label box sitting immediately on the right of the list box 301. For instance if the currently managed option is the bottom one within the list box 301, then this status information is shown in the label box 303; it can take the values “TRUE” or “FALSE”. If the user decides, for any reason not detailed here, to change the current status from “TRUE” to “FALSE” or conversely from “FALSE” to “TRUE”, then the user must click with the pointing device 105 on the push-button “Change” 304. The effect of this operation is reflected within the Option Manager Dialog Box 300 by swapping the “TRUE” and “FALSE” values shown in the label box 304. All these steps must be repeated for every option for which the user wishes to read and/or update the status. When done, the user uses the pointing device 105 to click on the push-button “Done” 306. This will result in closing the Option Manager Dialog Box 300 on the display device 106.

3. The third step occurs when the spreadsheet user decides, based on his or her own criteria not detailed here, whether the content of a given cell (referred to as the OAC) must depend or not on a given specified option.

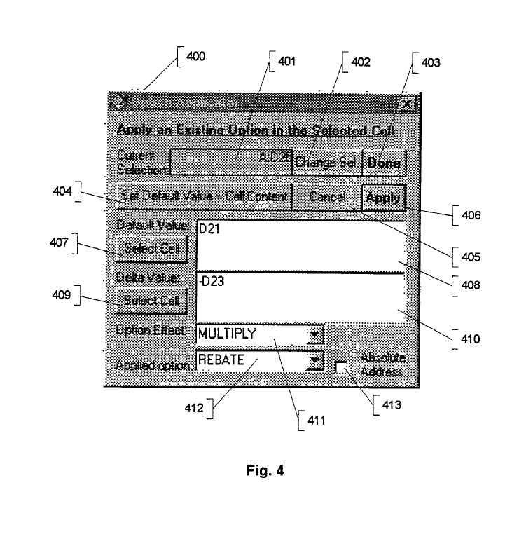

After having selected the cell where user-defined options must be applied, the user first invokes a specific command called “Option_Applicator” thanks to conventional means available in spreadsheet environment, such as (but not limited to) dedicated push-buttons, keyboard entry short cuts, menu or sub-menu entries. This results in displaying on the display device 106 an Option Applicator Dialog Box 400, as shown by FIG. 4.

Option Effect Combination

Within this Option Applicator Dialog Box 400, the user can visualise if an option has already been applied to the OAC, and if it is the case, what is the option effect. For this purpose, the Option Applicator Dialog Box 400 contains an “Option Effect” combination box 411 showing one of the following possible values:

“NONE” meaning that there is none option applied to the OAC;

“ADD” meaning that one option is applied, with additive effect;

“MULTIPLY” meaning that one option is applied, with multiplicative effect; and

“OR” meaning that one option is applied with exclusive effect.

If the user wishes either to apply a new option, or to modify an existing one, then it has just to use conventional means (such as for instance the pointing device 105 or some short cuts on the keyboard 104) to modify the content of the “Option Effect” combination box 411. Within this Option Applicator Dialog Box 400, the user can also visualise any already applied option to the OAC thanks to the “Applied Option” combination box 412 which displays the option affecting the OAC. The values displayed within the “Applied Option” combination box 412 correspond to the list of user-defined options, as defined and managed by the Option_Manager method. If the user wishes either to change an already applied option, or to specify a new option, then it has just to use conventional means (such as for instance the pointing device 105 or some short cuts on the keyboard 104) to modify the content of the “Applied Option” combination box 412 so that it displays the desired option.

Default Value

Within this Option Applicator Dialog Box 400, the user can also visualise the content of the OAC when the applied option is set to “FALSE”. For this purpose, the Option Applicator Dialog Box 400 contains a “Default Value” text box 408 showing the content of the OAC when the applied option is set to “FALSE”. In the specific example of FIG. 4, this default value corresponds to the content of the cell with address D21. If the user wishes to modify this default value, then it has just to use conventional means (such as for instance the pointing device 105 or some short cuts on the keyboard 104) to modify the content of the “Default Value” text box 408 so that it displays the desired modified value. Furthermore, if during this “Default Value” text box 408 update, the user needs to reference a cell or a range within the spreadsheet, then the user can use the pointing device 105 to first click on the “Select Cell” push-button 407, and then to point within the spreadsheet to the desired cell or range of cells which needs to be referenced. This action will result in appending, within the content of the “Default Value” text box 408 the address of the referenced cell or range. This feature is particularly useful when the default value must be specified as the result of some arithmetic between cells or ranges of cells.

Delta Value

Within the Option Applicator Dialog Box 400, the user can also visualise the variation of the content of the OAC (according to the effect specified in the “Option Effect” combination box 411) when the applied option is set to “TRUE”. For this purpose, the Option Applicator Dialog Box 400 contains a “Delta Value” text box 410 showing the variation of the content of the OAC when the applied option is set to “TRUE”. In the specific example of FIG. 4, this delta value corresponds to the opposite of the content of the cell with address D23. More generally, let call D the default value, as defined within the “Default Value” text box 408, let call D the delta value, as defined within the “Delta Value” text box 410 and let call E the value taken by the applied effect as specified within the “Option Effect” combination box 411. Then if the applied option (as specified within the “Applied Option” combination box 412) is “FALSE”, then the value taken by the OAC is equal to D, regardless of the value of E; if the applied option is “TRUE”, then the value taken by the OAC is respectively equal to D+D, or D*D, or D if the value of E is equal to “ADD”, or “MULTIPLY”, or “OR”. If the user wishes to modify the delta value, then it has just to use conventional means (such as for instance the pointing device 105 or some short cuts on the keyboard 104) to modify the content of the “Delta Value” text box 410 so that it displays the desired modified value.

Furthermore, if during this “Delta Value” text box 410 update, the user needs to reference a cell or a range within the spreadsheet, then the user can use the pointing device 105 to first click on the “Select Cell” push-button 409, and then to point within the spreadsheet to the desired cell or range of cells which needs to be referenced. This action will result in appending, within the content of the “Delta Value” text box 410 the address of the referenced cell or range. This feature is particularly useful when the delta value must be specified as the result of some arithmetic between cells or ranges of cells.

Relative/absolute Cell Reference

Within this Option Applicator Dialog Box 400, the user can also visualise and set if the applied option is referenced as an absolute reference of not. For this purpose, the Option Applicator Dialog Box 400 contains an “Absolute Address” check box 413 showing either a check mark or a blank field. In the former case, the applied option is referenced as an absolute reference and in the later case, it is referenced as a relative reference. By using conventional means such as the pointing device 105, the user can modify this setting by clicking on the “Absolute Address” check box 413, so that its display swaps between a check mark and a blank field.

Applying/modifying Option Effect

When the user is ready with either applying a new option effect to an OAC or with modifying an existing option effect to an OAC, the user can ‘record’ this action by clicking with conventional means such as the pointing device 105, on the “Apply” push-button 406. This results in updating the OAC content so that it contains the new or updated option effect. If the user wishes to apply more than one option within the OAC, the user must repeat the previous steps for each applied option, and furthermore reinitialise the OAC default value as the content of the OAC after having applied each option to the OAC. For this purpose, the Option Applicator Dialog Box 400 contains a “Set Default Value Cell Content” push-button 404 on which the spreadsheet user can click using conventional means like the pointing device 105. This results in replacing the content of the “Default Value” text box 408 by the content of the OAC, in clearing the content of the “Delta Value” text box 410, and in initialising the “Option Effect” combination box 411 to the value “NONE”. When this is done, the OAC still depends on the user-defined actions already specified by the spreadsheet user, as explained above, but now the user can specify a new option, a new effect and a new delta value respectively in:

the “Applied Option” combination box 412,

the “Option Effect” combination box 411, and

the “Delta Value” text box 410, as well as specify if this new option is referenced with absolute reference by using the “Absolute Address” check box 413.

Close/cancel

When the user has completed the task of specifying how one or several user-defined options apply to the OAC, the user can either close the Option Applicator Dialog Box 400, or continue working with another OAC.

If the user's choice is to close the Option Applicator Dialog Box 400, then the user can use conventional means such as the pointing device 105 to click on the “Done” push-button 403, or on the “Cancel” push-button 405. The resulting effect is that the Option Applicator Dialog Box 400 is closed on the display device 106.

If the user's choice is to continue working with another OAC, the user must first change the current OAC. For this purpose the Option Applicator Dialog Box 400 contains a “Change Selection” push-button 402 which can be clicked on by the pointing device 105. When done, the user can use the same pointing device 105 to select within the spreadsheet a cell which becomes the new OAC.

Current Selection

To visualise at any time which OAC is being handled, the Option Applicator Dialog Box 400 contains a “Current Selection” text box 401 which displays the address of the current OAC. Each time a new OAC is selected according to the means described above, the “Current Selection” text box 401 is updated to show the address of the new OAC.

C. Option_Applicator Method

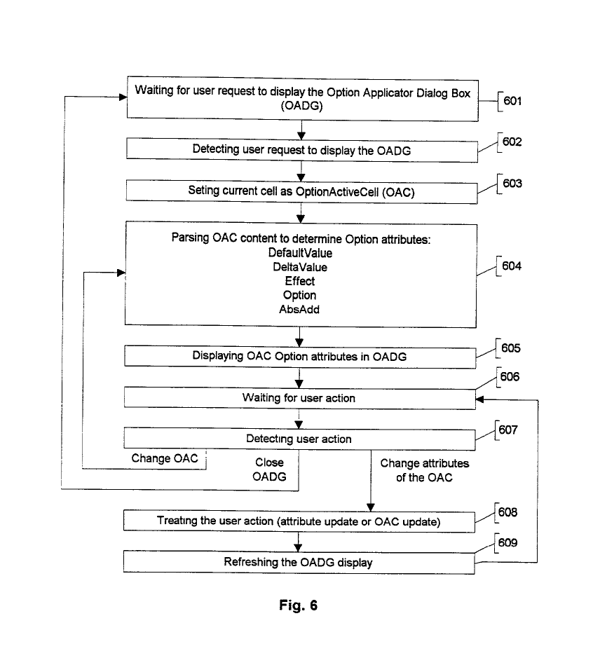

The present method of applying user-defined options is summarized in FIG. 6:

At step 601, the method is waiting for a user request to display on the display device 106 an Option Applicator Dialog Box (OADG) 400.

At step 602, a user request for displaying the OADG 400 on the display device 106 is detected.

At step 603, the OptionActiveCell (OAC) is set equal to the current cell. The OAC corresponds to the cell where options are applied.

At step 604, the content of the OAC is parsed to identify, if any, the attributes of already applied options. If no attribute is found, default attribute values are set.

At step 605, the OADG 400 is displayed on the display device 106 to show the OAC option attributes identified at the previous step.

At step 606, the method is waiting for a user action on the OADG 400.

At step 607, a user action on the OADG 400 is detected.

If the user action corresponds to a change of the OAC, then control is given to the step 604;

if the user action corresponds to a change in one of the current OAC option attributes, then control is given to the step 608;

if the user action corresponds to the closure of the OADG 400, then control is given back to the initial step 601.

At step 608, the OAC attribute update is treated according to the user action on the OADG 400.

At step 609, the OADG 400 is refreshed to reflect the attribute update resulting from the user action. Then control is given back to step 606 to wait for any future user action.

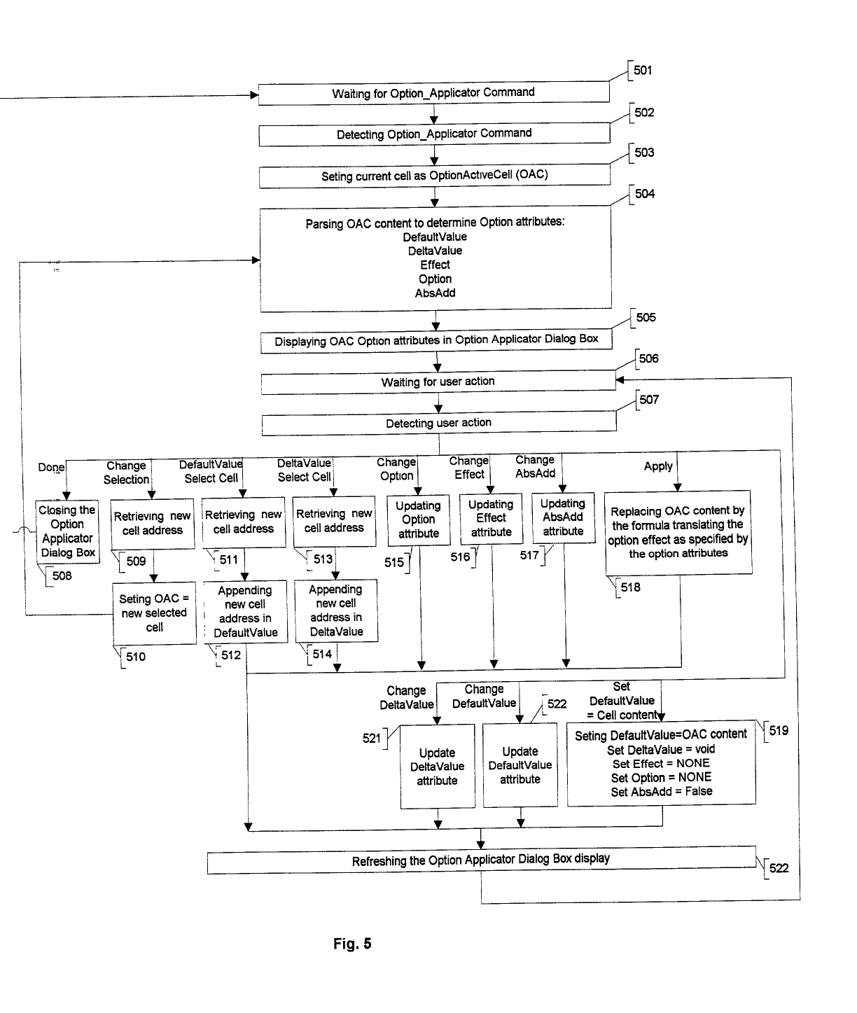

The method of applying user-defined options within a given cell named ActiveOptionCell or OAC, is detailed in flowchart 500 of FIG. 5. This method can be seen as the processing of the Option_Applicator command, whether it is used to apply one or several new options within an OAC, or to update an OAC where one or several options were already applied. The method comprises the following steps

At step 501, the method is in its default state, waiting for an event to initiate the process.

At step 502, an event is detected, as a result of a user action. This action can be for instance a specific combination of keys on the keyboard 104, or the click of the pointing device 105 on a specific button, or any other similar means not further specified here.

At step 503, the OAC is set equal to the currently selected spreadsheet cell.

At step 504, the content of the OAC is parsed to identify any previously applied option. This can be done by conventional means such as, but not limited to a content interpreter. The output of this parse operation is the determination of the option attributes of the OAC, which correspond to the following elements:

DefaultValue corresponds to the OAC value, when the applied option takes the value ‘FALSE’. If none option were previously applied within the OAC, then the DefaultValue attribute corresponds to the OAC content.

DeltaValue corresponds to the variation of the OAC value, when the applied option takes the value ‘TRUE’. If none option were previously applied within the OAC, then the DeltaValue attribute is void.

Effect corresponds to the way the DeltaValue variation affects the DefaultValue. The effect can be additive, or multiplicative or exclusive, so that the OAC content corresponds respectively to DefaultValue+DeltaValue, or DefaultValue*DeltaValue, or DeltaValue, when the applied option takes the value ‘TRUE’. If none option were previously applied within the OAC, then the Effect attribute takes the value ‘NONE’.

Option corresponds to the user-defined option affecting the value of the OAC. If none option were previously applied within the OAC, then the Option attribute takes the default value ‘NONE’.

AbsAdd is a logical variable indicating if the applied option is referenced as an absolute or relative reference. It can take the values ‘TRUE’ or ‘FALSE’. If none option were previously applied within the OAC, then the AbsAdd attributes takes the default value ‘FALSE’.

At step 505, the Option Applicator Dialog Box 400 is displayed on the display device 106. Within the Option Applicator Dialog Box 400, the cell address of the OAC is displayed within the “Current Selection” text box 401, the DefaultValue attribute is displayed within the “Default Value” text box 408, the DeltaValue attribute is displayed within the “Delta Value” text box 410, the Effect attribute is displayed within the “Option Effect” combination box 411, the Option attribute is displayed within the “Applied Option” combination box 412, and the AbsAdd attribute, when equal to ‘TRUE’, forces a check mark in the “Absolute Address” check box 413.

At step 506, the method is waiting for any user action on the Option Applicator Dialog Box 400. Such user action is typically resulting from a click with the pointing device 105, possibly followed by text entry from the keyboard 104, but can also result from other similar means not further specified here.

At step 507, a user action on the Option Applicator Dialog Box 400 is detected. If the user action is a click on the push-button “Done” 403 or on the push-button “Cancel” 405, then control is given to step 508; if the user action is a click on the push-button “Change Selection” 402, then control is given to step 509; if the user action is a click on the push-button “Select cell” 407, then control is given to step 511; if the user action is a click on the push-button “Select cell” 409, then control is given to step 513; if the user action is any combination of click with the pointing device 105 and data entry with the keyboard 104 resulting in an update of the “Applied Option” combination box 412, then control is given to step 515; if the user action is any combination of click with the pointing device 105 and data entry with the keyboard 104 resulting in an update of the “Option Effect” combination box 411, then control is given to step 516; if the user action is a click on the check box “Absolute Address” 413, then control is given to step 517; if the user action is a click on the push-button “Apply” 406, then control is given to step 518; if the user action is a click on the push-button “Set Default Value=Cell Content” 404, then control is given to step 519; if the user action is any combination of click with the pointing device 105 and data entry with the keyboard 104 resulting in an update of the content of the “Default Value” text box 408, then control is given to step 520; and if the user action is any combination of click with the pointing device 105 and data entry with the keyboard 104 resulting in an update of the content of the “Delta Value” text box 410, then control is given to step 521.

At step 508, the Option Applicator Dialog Box 400 is closed, so that it disappears from the display device 106, and control is given back to the initial step 501 for treating any future Option_Applicator command.

At step 509, the method uses conventional means to let the user select a cell within the spreadsheet. Such means may for instance rely on a pop-up window within which the user enters through the keyboard 104 the address of the cell to select, or such means may also rely on a pointing device 105 mode where the user clicks on the cell to select, or such means may rely on other similar ways not further described here.

At step 510, the OAC becomes the cell selected during the step 509, and then control is given back to the step 504, so that the new OAC attributes be determined before being displayed within the Option Applicator Dialog Box 400.

At step 511, the method uses conventional means to let the user select a cell within the spreadsheet. Such means may for instance rely on a pop-up window within which the user enters through the keyboard 104 the address of the cell to select, or such means may also rely on a pointing device 105 mode where the user clicks on the cell to select, or such means may rely on other similar ways not further described here.

At step 512, the character string corresponding to the address of the cell selected during the step 511 is appended at the end of the DefaultValue attribute of the OAC. Then control is given to step 522.

At step 513, the method uses conventional means to let the user select a cell within the spreadsheet. Such means may for instance rely on a pop-up window within which the user enters through the keyboard 104 the address of the cell to select, or such means may also rely on a pointing device 105 mode where the user clicks on the cell to select, or such means may rely on other similar ways not further described here.

At step 514, the character string corresponding to the address of the cell selected during the step 513 is appended at the end of the DeltaValue attribute of the OAC. Then control is given to step 522.

At step 515, the Option attribute of the OAC is changed to take the value hold in the “Applied Option” combination box 412. Then control is given to step 522.

At step 516, the Effect attribute of the OAC is changed to take the value hold in the “Option Effect” combination box 411. Then control is given to step 522.

At step 517, the AbsAdd attribute of the OAC is changed to reflect the presence of the check mark within the “Absolute Address” check box 413: if the check mark is present, then the AbsAdd attribute of the OAC is set equal to ‘TRUE’, otherwise it is set equal to ‘FALSE’. Then control is given to step 522.

At step 518, the content of the OAC is updated to reflect the current values hold within the different OAC option attributes. This content can take for instance the form of a specific formula, not further detailed here, which adequately translates how one or several options are applied to the OAC. Then control is given to step 522.

At step 519, the option attributes of the OAC are updated as follows: the DefaultValue attribute is set equal to the content of the OAC; the DeltaValue attribute is set equal to void; the Effect attribute is set equal to ‘NONE’; the Option attribute is set equal to ‘NONE’, and the AbsAdd attribute is set equal to ‘FALSE’. Then control is given to step 522.

At step 520, the DefaultValue attribute of the OAC is changed to take the value hold in the “Default Value” text box 408. Then control is given to step 522.

At step 521, the DeltaValue attribute of the OAC is changed to take the value hold in the “Delta Value” text box 410. Then control is given to step 522.

At step 522, the Option Applicator Dialog Box 400 is refreshed on the display device 106 so that the option attributes of the OAC, potentially updated during the steps 511 to 521, be updated within the relevant elements 401, 408, 410, 411, 412 and 413 of the Option Applicator Dialog Box 400. Then control is given to the step 506, so that any future user action be first waited for (step 506), then detected (step 507), and then treated (steps 508 to 521).

Alternate Embodiments

While the invention has been particularly shown and described with reference to a preferred embodiment, it will be understood that various changes in form and detail may be made therein without departing from the spirit, and scope of the invention.

The Option_Applicator method and system according to the present invention may be used advantageously in those environments where elements of information are organised as multidimensional tables having more than three dimensions.

What is claimed is:

1. A method of applying one or a plurality of options in one or a plurality of cells in a multi dimensional spreadsheet comprising a plurality of cells identified by a cell address along each dimension, said method comprising the steps of:
defining for each option a boolean variable with a first value and a second value, preferably a “true” or “false” value;
for each of said one or plurality of cells:
referencing one or a plurality of boolean variables;
associating a logical or mathematical operation with each boolean variable;
for each of said one or plurality of referenced boolean variables in each of said one or plurality of cells:
specifying a default value, said default value being defined as the value of the cell when the referenced boolean variable is set to the first value, preferably when the boolean variable is set to the “false” value;
specifying a delta value by applying to the specified cell default value, the operation associated with the referenced boolean variable when the boolean variable is set to the second value, preferably when the boolean variable is set to the “true” value;
setting each boolean variable to the first value or to the second value;
for each of said one or plurality of cells:
computing said one or plurality of delta values.

2. The method according to the preceding claim wherein the step of computing said one or plurality of delta values comprises the further step of:
computing the value of the cell from said one or plurality of computed delta values.

3. The method according to the preceding claim wherein said step of associating a logical or mathematical operation with each boolean variable, comprises the preliminary step of:
specifying either an additive, or a multiplicative or an exclusive operation.

4. The method according to any one of the preceding claims wherein said step of specifying a delta value comprises the further step of:
defining the delta value as either an additive increment, or a multiplicative factor or an alternate value applied to the specified cell default value when the boolean variable is set to the first value preferably when the boolean variable is set to the “true” value;

5. The method according to any one of the preceding claims comprising the further step of:
for each of said one or plurality of referenced boolean variables in each of said one or plurality of cells:
specifying whether the boolean variable is referenced in the cell by an absolute reference or not, so that any copy-paste operation performed on the cell results in a cell where the same boolean variable is referenced.

6. The method according to any one of the preceding claims wherein said steps of defining one or a plurality of boolean variables, associating a logical or mathematical operation with each boolean variable, setting each boolean variable to the first value or to the second value are executed by means of an interactive user interface.

7. The method according to any one of the preceding claims wherein said interactive user interface comprises a dialog box, displayed on a screen of a computer system.

8. A system comprising means adapted for carrying out the method according to any one of the preceding claims.

9. A computer program comprising computer readable instructions adapted for carrying out the method according to claims 1 to 7.
